(19) United States
(12) Patent Application Publication
(10) Pub. No.: US 2016/0198341 A1
(43) Pub. Date: Jul. 7, 2016

(54) Communication Between a Mobile Device and Telecommunications Network

(71) Applicants: KONINKLIJKE KPN N.V., The Hague (NL); NEDERLANDSE ORGANISATIE VOOR TOEGE- PAST-NATUURWETENSCHAPPELIJK ONDERZOEK TNO, 's-Gravenhage (NL)

(72) Inventor: Frank Fransen, Zuidhorn (NL)

(73) Assignees: Koninklijke KPN N.V., The Hague (NL); NEDERLANDSE ORGANISATIE VOOR TOEGEPAST- NATUURWETENSCHAPPELIJK ONDERZOEK TNO, 's-Gravenhage (NL)

(21) Appl. No.: 14/650,761

(22) PCT Filed: Dec. 10, 2013
(86) PCT No.: PCT/EP2013/076064

§ 371 Date: Jun. 9, 2015

(30) Foreign Application Priority Data
Dec. 11, 2012 (EP) 12196419.1

(51) Int. Cl. H04W 12/02; H04L 29/06; H04W 12/12

(52) U.S. Cl. CPC H04W 12/02; H04W 12/12; H04L 63/0853

(57) ABSTRACT

A system is described for communicating with a mobile telecommunications device (201) in a telecommunications network (207). The mobile telecommunications device (201) comprises first and second security applications. The second security application (209) is comprised in a smart card (204), typically the UICC of the mobile device (201). There is a secure logical channel between the first and second security applications which stops any malicious software resident on the device from interfering with communication between the first and second security applications. The telecommunications network (207) produces data and signals it to the mobile telecommunications device (201) which stores the data in the second security application (209) for access by the first security application (208). Typically either the second security application (209) notifies the first security application (208) when the data is stored, or, the second security application (209) sets a flag when data is stored and the first security application (208) periodically checks for the presence of the flag.

The invention relates to a system to communicate with a mobile telecommunications device, and to a mobile telecommunications device, arranged to communicate with a telecommunications network.

Telecommunications networks provide radio telecommunication to users of mobile devices, typically according to agreed and standardised radio protocols, for example GSM, UTMS and LTE as would be known by the skilled person.

Mobile telecommunications devices are common and include mobile phones and in particular smartphones, tablet devices and other handheld computer devices, handheld personal assistants, and even communication devices situated in vehicles. All can provide users with telecommunication with each other and with access to the internet while moving around.

Access to the internet exposes devices to malware and malicious applications that may be downloaded, accidentally or otherwise, onto the mobile device from the internet. Typically, and often because of their smaller size and memory capacity, mobile telecommunications devices do not contain security features which are as stringent as those available for desk computers and other large devices with internet access. As such, these smaller mobile telecommunications devices are vulnerable to infection and attack by malware and malicious applications, which will typically infect the application processor of a mobile device. But because mobile telecommunications devices are also typically in direct contact with a radio telecommunications network the telecommunications network itself is vulnerable to attack from any malware or malicious applications residing on the mobile devices.

Existing attempts to deal with malware have focused on methods which are applied entirely within the mobile handset itself. For example, “Taming Mr Hayes: Mitigating signaling based attacks on smartphones”, IEEE/IFIP International Conference on Dependable Systems and Networks (DSN 2012), 2012, dsn, pp. 1-12, Collin Mulliner, Steffen Liebergeld, Matthias Lange, Jean-Pierre Seifert, describes a method of detecting aberrant or malicious behaviour from within the application processor of the mobile phone itself using a virtual partition of the application processor.

Once malware has been detected it is a problem to communicate dependably with the infected device because if device harbours malware it cannot be trusted.

### DESCRIPTION OF THE INVENTION

The invention is described in the claims.

The claims describe a system comprising a telecommunications network and a mobile telecommunications device which are arranged to communicate with each other. The mobile telecommunications device includes a first security application, a second security application comprised on a smart card and a secure logical channel between the first security application and the second security application. The telecommunications network is arranged to produce data and signal the data to the mobile telecommunications device and the mobile telecommunications device is arranged to store the data in the second security application for access by the first security application.

This solves the problem of how to communicate in a dependable or reliable way with the mobile device because by storing, or saving, data in a second security application which is connected to a first security application in the device via a secure logical channel the first security application can read the data from the telecommunications network in a manner that cannot be compromised by any malware resident on the mobile device.

In an advantageous embodiment the second security application notifies the first security application when the data is stored. Typically this will occur as soon as data arrives to be stored in the second security application, or at least within a clock cycle, and in this manner the first security application can be made aware as soon as data arrives from the network.

In an alternative advantageous embodiment the second security application is arranged to set a flag when the data is stored and the first security application is arranged to periodically check for the presence of the flag. In this manner the first security application can find the data from the network without excessive use of resources in the mobile device. In this embodiment the second security application does not have to be programmed to transmit messages to the first security application, it merely has to set a flag.

The second security application is comprised on the smart card of the mobile device, and in a further particularly advantageous embodiment the smart card is a UICC. This allows the data to be safely stored in the second security application because the UICC, as is known to the skilled person, is a secure component and therefore any malware resident on the mobile device, for example in the application processor, cannot retrieve or alter information in the UICC. Further to this, communication between the network and the UICC of a device is securely encrypted. Typically the UICC contains a SIM application as is known to the skilled person.

The data which is communicated to the mobile device from the network will typically be data important to the secure functioning of the mobile device in the event that it is infected by malware. Typically this data will be generated within the network as a result of detecting that the mobile device is infected with, or potentially infected with malware.

In an advantageous embodiment the data is a report, in a further advantageous embodiment the data is a detection report, in other words a signal or notice that malicious behaviour has been detected in connection with the device.

The most important data to communicate to the mobile device is the very fact that it has been or might have been infected by malware and in a particularly advantageous embodiment the first security application is prompted to display a message to the user wherein the message is based upon the contents of the data which has been stored in the second security application. In this way the network can prompt or force the mobile device to display a message to the user informing him or her that the device they are using has been infected, or is suspected of being infected, by malware. This is particularly important because typically the user of a mobile device cannot tell if the device has been infected by malware.

In a further advantageous embodiment the message displayed to the user includes instructions to guide the user to a helpdesk facility, such as a telephone or online helpdesk. In this way the operator of the telecommunications network can guide the user of the mobile device to a point of presence where they can receive assistance.

In an alternative embodiment the first security application is prompted to select and run a program within the mobile telecommunications device and typically the selection of the program is based upon the contents of the data held in the second security application. In this manner the mobile device can be instructed to run a program which identifies and deletes malware, or to run a program which shuts down or restricts functionality on the mobile device which the malware might typically attempt to exploit. For example, malware might attempt to download video streams from the internet over a telecommunications network and the network might therefore instruct a mobile identified as infected not to open applications or sub-routines which allow the downloading of video streams.

In an advantageous embodiment the first security application is situated in the application processor of the mobile device.

In an advantageous embodiment the first security application is provided by the operator of the telecommunications network and assists with security of the mobile device, including functionality such as virus scanning, firewalling and browser protection. Additionally it can be programmed to coach the user of the device in suitable security aware behaviour. Further the security application is programmed to read the detection report and act upon it.

The secure channel set up between the first and second security applications can be arranged according to existing standard ETSI TS102 484 and ensures that communication between the first and second security applications cannot be compromised. In other words it ensures that any malware resident on the mobile device cannot read, intercept or interfere with the communication between the first and second security applications and potentially stop the first security application from undertaking action against the malware.

Thus the problem of how a telecommunications network can dependably communicate with a device infected by malware is solved, because by use of the arrangement of security programs and secure channel, the telecommunications network can bypass any malware, and once the first security application has access to the information from the network it can take appropriate action, as programmed. In particular the first security program can inform the user through the user interface and/or further guide the user to a helpdesk.

Detection of malicious behaviour can be achieved according to the following method.

A system can be used for detecting behaviour of a mobile telecommunications device in a telecommunications network. Typically this behaviour will be malicious, or abnormal, behaviour. The system includes a telecommunications network configured to identify at least one mobile telecommunications device and to receive signals from the mobile telecommunications device and further to process the signals into data streams. The data streams include data of a first type arranged to cause an event of a first type within the telecommunications network. The network is arranged to monitor an occurrence in the data streams of the data of the first type and is arranged to register when the occurrence exceeds a level indicating acceptable behaviour of the mobile telecommunications device in the telecommunications network.

This system identifies malicious, or abnormal, behaviour in a mobile device, but identifies it from within the telecommunications network itself. This is done by monitoring the data streams, or transfers of data, which occur in the network due to the interaction between the network and the mobile. This data is monitored for excessive occurrences of particular signals.

Malware resident on a mobile device may cause that device to indulge in malicious behaviour, which is typically anything that uses up network resources without being for an express user intention. Typically it is anything which uses up network resources but without resulting in a benefit for the user or for the device. For example, a user of a mobile device may wish to download a video to watch on the device. This will use up resources but the use of resources in this case is time limited and in any event, once the video is downloaded the user spends time watching the video and while doing so is unlikely to download other videos or perform other tasks. Malware, however, may be programmed to download videos continuously, and this uses excessive network resources. In an alternative example, malware may be programmed to continuously perform attach and detach of the mobile device onto the network. This will use excessive network resources because the network will try to authenticate the mobile device every time the device attaches. The continuous attach and detach however does not result in an advantage for either the user or the mobile device. In an alternative example, malware may be programmed to manipulate signal level reports used by the network for handover decisions. The mobile device continuously measures the signal levels from base stations in the surrounding cells and reports the signal levels to the network. The network uses this, and other information, to device whether or not to handover the communication with the mobile device to a different base station than the one that is currently serving the mobile device. Malware could be programmed to manipulate the measurement reports in such a way that a very large number of handovers takes place, which uses excessive network resources. In an alternative example the malware may be programmed to force the mobile device which carries the malware to continuously request call forwarding. When a request for call forwarding is made the device requests the network to forward incoming calls to a second number. The continuous making of this request will use up network resources. In an alternative example the malware may constantly request the setting up of bearers, and in particular new bearers, between the device and the network. Again, this uses up network resources. In an alternative example the malware may force the mobile device which carries the malware to continuously make requests for service without using the proffered services. These requests may be for any kind of service typically provided by the telecommunications network but it wastes network resources when the continuous requests for service do not result in a provided service which benefits either the user or the mobile device making the request.

In all these examples an exchange of data occurs between the mobile device and the telecommunications network but also further within the telecommunications network itself. When the mobile device transmits signals to the telecommunications network they are received in a base station and processed into data streams internal to the telecommunications network. For example, if an attach request is made by a mobile device then the telecommunication network which receives the attach request makes an attempt to authenticate the mobile device. This results in data streams, or signals, being sent between, for example in the case of a UMTS network, the radio network controller RNC, the mobile switching centre MSC, the Home Location Register HLR, and the Authentication Centre AuC, as would be known by the skilled person. As would also be known by the skilled person, other malicious behaviours described would also result in signalling, or data streams, transmitted not just between the device and the network but also within the network itself.

The network can therefore detect malicious behaviour by monitoring the occurrence in the data streams in the network of data of a first type, typically a predetermined type which represents some interaction in the network between network devices for the normal processing of signals. Further the network registers when this occurrence exceeds a level which indicates acceptable behaviour of the mobile telecommunications device in the telecommunications network. In other words, the network detects malicious behaviour by monitoring for, and detecting, the incidence of various types of data steams within the network itself and registering when the occurrence is too high.

For example, in order to detect the malicious behaviour in which a device continuously attempts to attach and detach the network may count the number of times the Mobile Switching Centre, MSC, is caused to request authentication of the device at the Authentication Centre AuC, or alternatively count the number of times the Authentication Centre AuC signals back a reply.

In a particularly advantageous embodiment the detection of data steams is performed in the core network, and in particular in the Mobility Management Entity MME if the network is an LTE network, in the MSC if it is a UMTS or GSM network or the Serving Gateway Support Node SGSN in a GPRS network. In this embodiment the incidence of particular, or predetermined, data streams can be identified in a central location within each respective network. This has the advantage that it reduces the time it takes for the telecommunications network to identify mobile devices which may be infected by malware.

However the occurrence of specific data streams may be detected further back in the network. In an example of this, excessive attach requests may be detected at the AuC by detecting authentication attempts per mobile device. Alternatively, excessive attach requests may be detected by counting at the HLR the number of times the network requests data regarding a particular mobile device.

In certain embodiments detection could be performed in the eNodeB or base station. This has the advantage that detection of malicious behaviour uses fewer network resources. For example, excessive numbers of attach and detach could be detected in the receiving base station. However, a particular disadvantage of performing detection at the base station, for example, occurs when signals from the mobile device arrive in the network through different base stations, and one example of this is when a device is physically moving quickly across base station cells. In such a case no one particular base station, or eNodeB, will necessarily receive the full signalling from the device and therefore no one base station will be able to unambiguously perform detection.

In a particularly advantageous embodiment the network counts the occurrence of particular data signals when their rate of occurrence exceeds a predetermined temporal rate. For example, if the network is monitoring for the sending of an authentication request to the AuC, the network is arranged to detect when the rate of transmission of authentication requests for a particular mobile exceeds a predetermined threshold and also to count the number of times authentication is then requested, while the rate of authentication requests exceeds the predetermined rate.

In other words the network monitors for, and detects when the frequency of a certain predetermined signal or data occurrence in the data streams becomes too high. The network then proceeds to count the number of occurrences while the rate remains above the predetermined temporal rate.

This particular embodiment is even more advantageous if the network is further arranged to register when the number of detected occurrences itself exceeds a predetermined threshold. In our example this would mean that the network registers when the number of authentication requests exceeds a certain number, with each authentication request having been received at a rate which is greater than the predetermined temporal rate.

In a further advantageous embodiment, the network can detect if the rate of occurrence of a signal or data event, for example a request for authentication transmitted to the AuC, occurs at or above a predetermined temporal rate by measuring the time elapsed between successive occurrences. In this embodiment the network is arranged to detect the time elapsed between two consecutive authentication requests to the AuC, in our example, and calculate when this elapsed time is less than a predetermined time interval. The data occurrences are deemed to occur at a rate which exceeds the predetermined rate when they occur within the respective predetermined time interval.

In a particularly advantageous example the network includes a counter, C, and is arranged to detect a detectable event, X, which occurs within the network, for example the first instance of an attach, or, the transmission of a request for authentication to the AuC, or, the arrival of signaling in the MME indicating that a handover has taken place, and starts the counter.

The counter then becomes: C=1

At the same time the network starts a timer. The counter is stored and associated with the mobile device.

If the next detection of X in the network takes place within a predetermined time interval then the counter becomes: C=2

In an embodiment the timer measures a time t from the first detection of X and in this case the counter is incremented by 1 if the next detection occurs at a time, t<A, where A is the predetermined time interval. In an alternative embodiment the time at each detection of the event X is registered, the time of the first event, ST, being stored and associated with the mobile device. A timer, T, is started at ST and the counter is incremented if the time of the next detected event X is t where:

t<ST+Δ

Within this embodiment the value of ST is then replaced by the new time NT at which the second event X was detected.

In both embodiments the counter is incremented again if the following detection of X occurs within the same time interval. In such a case the counter would now register:

C=3

If the counter reaches a predetermined threshold, say Cₙ, in which case the counter becomes:

C=Cₙ

the telecommunications network registers the fact. This may be done by setting a flag, but the skilled person knows that there are alternative methods of registering.

In an alternative embodiment the network registers if the counter exceeds a predetermined threshold. If X is not detected again within the predetermined time interval, the counter goes back to zero.

In an alternative embodiment the network could monitor and count the number of detachments of a particular mobile device.

In an embodiment in which handover is detected, the following further embodiment is particularly advantageous. The network maintains a record of the tracking area of the mobile device and also an indication of when the tracking area changes. This allows the network to know when the device is moving. If the network registers an excessive number of handovers the tracking area information can be used to discount excessive handovers when the device is actually in physically rapid movement.

In a further embodiment the network registers when a device switches frequently between neighbouring bases stations. This is an indication of genuine mala fide behaviour as normally such switches are suppressed by existing handover algorithms to avoid excessive handover of a mobile device that is actually physically situated on the border between two cells.

In an alternative, and particularly advantageous embodiment, the network monitors improbable service request combinations. For example, it is unlikely that a user would request the streaming of five movie downloads in parallel. Equally unlikely is that the user would genuinely attempt to listen to his own voice mail while making a telephone

Following detection of malicious behaviour the network can perform several actions. These include: detaching the mobile device; sending a signal to the device to permanently block access to the network; starting a back off timer to stop the mobile device from making another connection request within a certain time period; send a warning message to the owner of the device. In the last example the warning could be transmitted to the mobile device itself, via sms for example, however if the device is infected by malware and cannot be trusted then the network cannot assume any warning message transmitted to the device itself will be seen or heard by the user. Therefore a warning could be transmitted to the user via other channels relying on other data stored for the user, for example by email to a known email address.

In a further advantageous embodiment the network tracks the behaviour of several devices and aggregates the results. In this way malware behaviour can be tracked and monitored across an entire network.

In a further advantageous embodiment the network monitors for the occurrence of data of a second type in the data streams. Typically the data streams that are passed around the network include more than one type of data and in addition to including data of a first type arranged to cause an event of a first type within the telecommunications network, may include data of a second type arranged to cause an event of a second type with the telecommunications network. In a particularly advantageous embodiment the network may monitor for malicious behaviour of a mobile device by monitoring for the occurrence of both data of the first and second type, determining when each exceeds some predetermined threshold. In this case each can exceed a predetermined threshold individually, and the predetermined thresholds can be different or be the same, or, both occurrences can be aggregated and can be compared to a single predetermined threshold together. In an example the network could monitor for data occurrences in the network indicating device attach, as has already been described, but additionally monitor for data occurrences indicating device detach, and only if both occurrences exceed independent predetermined thresholds does the network register that malicious behaviour is occurring. This double measurement, although using extra network resources by effectively counting device behaviour twice, provides the network with a failsafe against accidental registers of malicious continuous attachment due to extraneous other factors within the network, such as error.

In an alternative embodiment, the network could count the occurrence of data of a first type indicating handover, and also count the occurrence of data of a second type indicating change of tracking area.

Further embodiments of the invention are shown in the Figures.

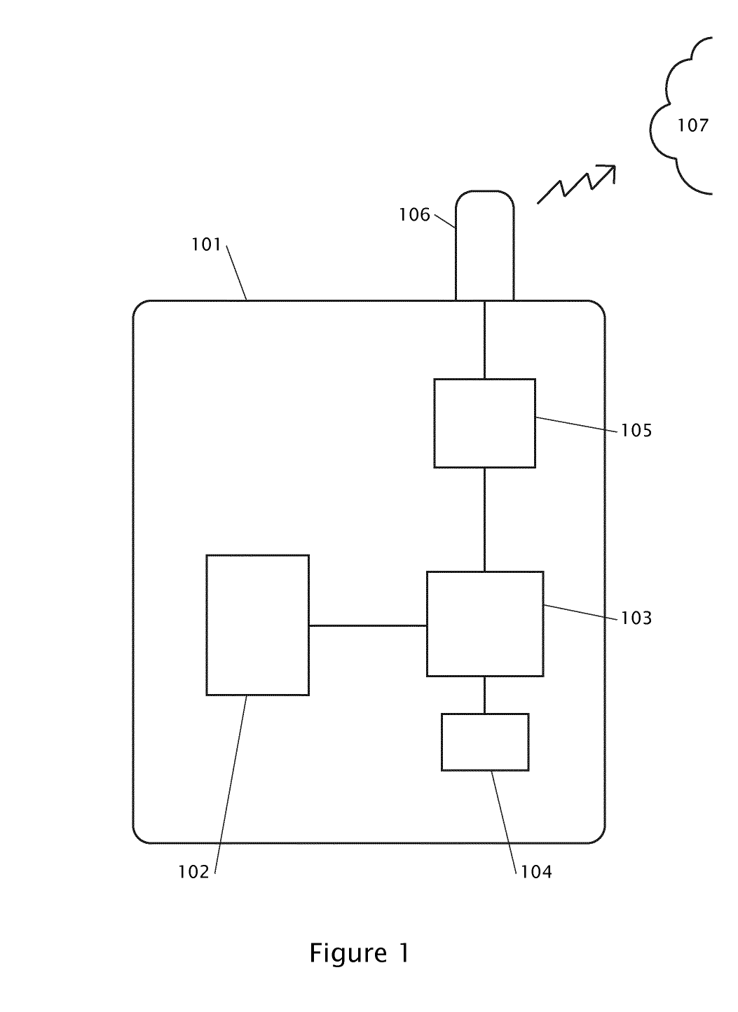

FIG. 1 shows a mobile device suitable for use of the invention.

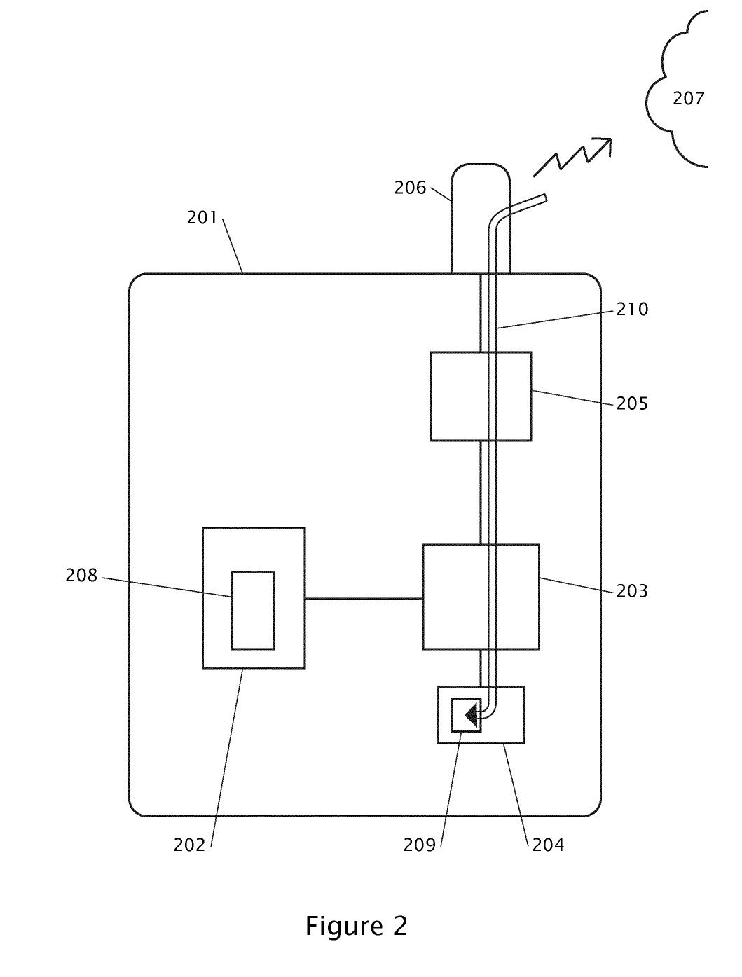

FIG. 2 shows a mobile device comprising an embodiment of the invention.

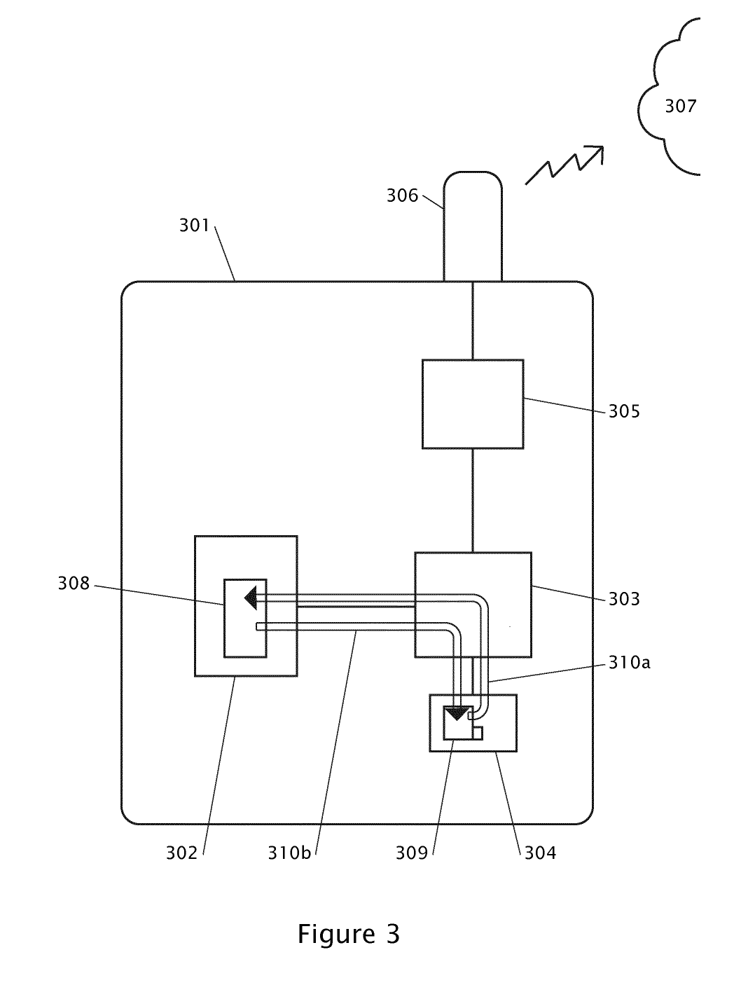

FIG. 3 shows two embodiments of the invention.

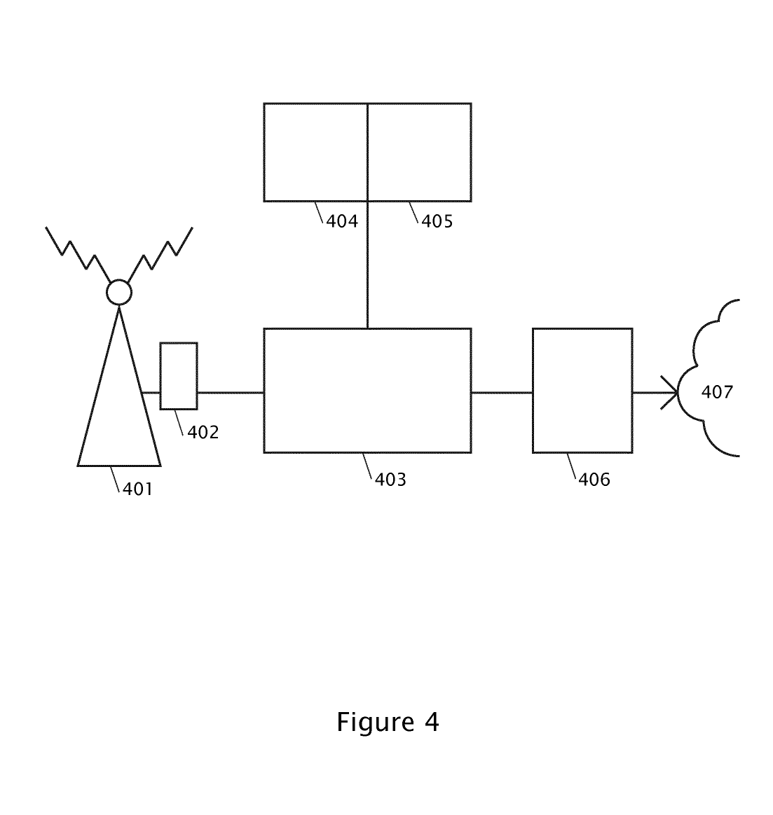

FIG. 4 shows a telecommunication network in which abnormal behaviour of the mobile can be detected.

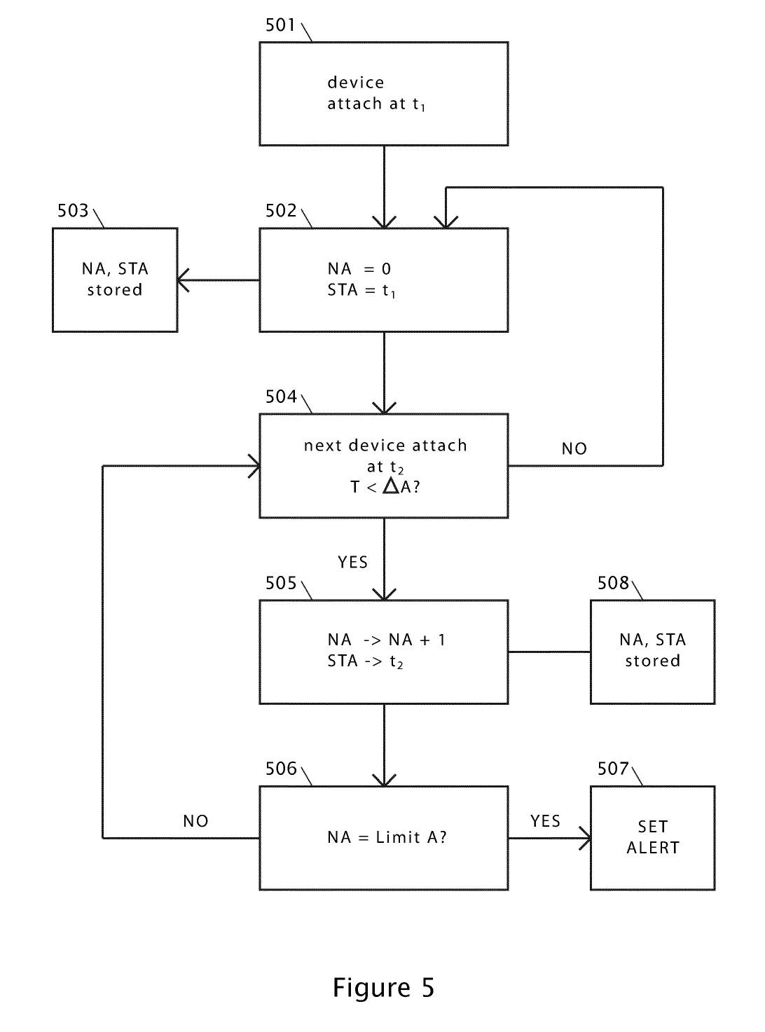

FIG. 5 shows a flow diagram of an embodiment of detection of malicious, or abnormal, behaviour.

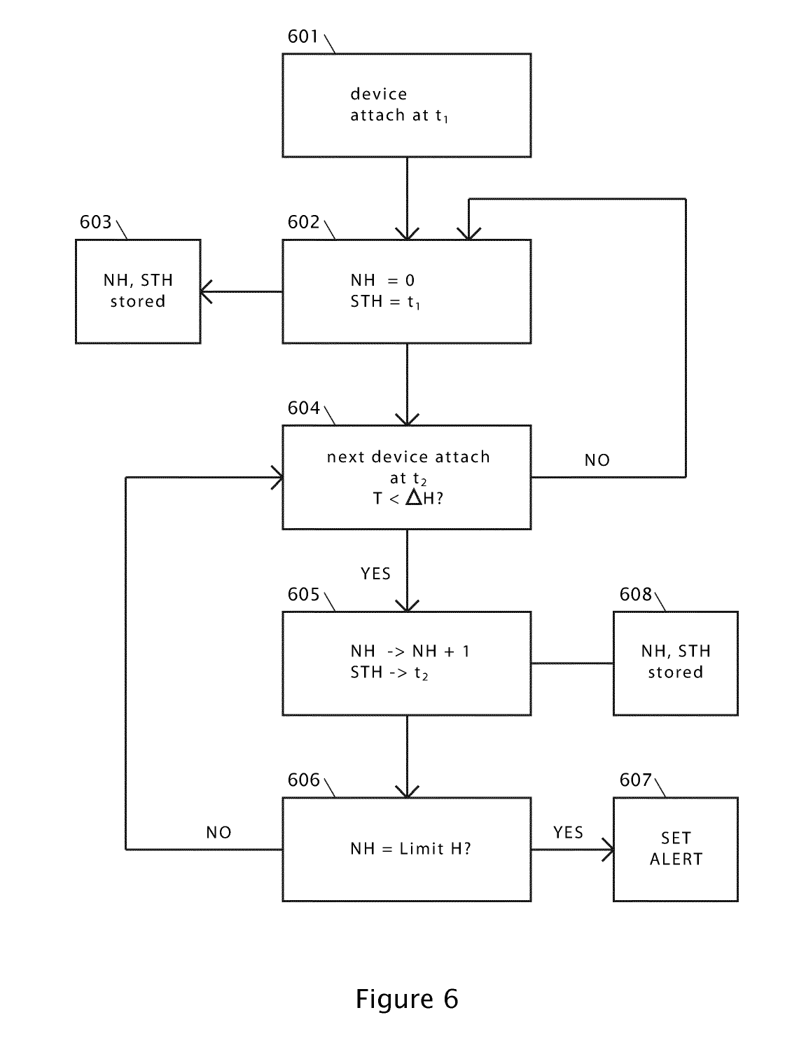

FIG. 6 shows a flow diagram of an embodiment of detection of malicious, or abnormal, behaviour.

In the Figures equivalent or similar items are shown with equivalent numbering.

FIG. 1 shows a mobile device 101 according to the prior art. The device comprises an application processor 102, a baseband processor 103, in communication with a smart card, or UICC, 104, and a radio controller 105 to control radio communication of mobile device 101 through antenna 106 with telecommunication network 107.

As would be known by the skilled person, mobile device 101 would also include an input device, for example a touch pad, trackpad, keyboard, number pad, or touchscreen, and output device such as a screen, but these are not shown.

FIG. 2 shows a mobile device 201 comprising an embodiment of the invention. Application processor 202 comprises a first security application 208, and smart card 204, in communication with baseband processor 203, now comprises a second security application 209. Antenna 206, controlled by radio controller 205 is in communication with telecommunication network 207.

Telecommunications network 207 is able to signal mobile device 201 with data which arrives 210 in mobile device through antenna 206, is passed via radio controller 205 to baseband processor 203 which transfers the data to smart card 204 which provides the data to second security application 209.

FIG. 3 shows two embodiments of the invention in which data has been received by second security application 309 residing on smart card 304, having been received by mobile device 301 through antenna 306 and transferred by radio controller 305 to baseband processor 303 and then to smart card 304. The second security application 309 in a first embodiment transmits 310a information to first security application 308 and in this way first security application 308 becomes aware that data has arrived at the second security application 309. In this first embodiment second security application 309 can transmit a message to first security application 308 to tell first security application that data has been received, or the second security application 309 can transfer the actual data to the first security application 308. In the second embodiment, 310b, the first security application 308 checks to see if information or data has arrived at the second security application 309. This check may be made periodically. Typically, in this embodiment the second security application sets a flag 311 upon receipt of data and the first security application 308 merely checks to see if the flag 311 has been set. Flag 311 may be in the second security application or may reside elsewhere on smart card 304. If the flag has been set then first security application 308 queries second security application 309 to recover the stored data.

In an alternative embodiment the network can set security flag 311 on the smart card. Typically the data, or detection report, is written using OTA/SIM Toolkit, which is a product known to the skilled person.

FIG. 4 shows a telecommunications network in which malicious behaviour is detected. As is known by the skilled person there are multiple technologies described by various telecommunication standards that define telecommunications systems. Typically they include the following layout though the skilled person knows and appreciates that there may be small variations and differences in the way systems work.

A telecommunications network includes a transmitter 401. This is usually called a base station, cell tower, or, in an LTE network an eNodeB. The transmitter is controlled by a base station controller 402, though in, for example, a UMTS network this would be a Radio Network Controller 402 and in, for example, an LTE network the control functions of the base station controller 402 may be subsumed into the eNodeB. Radio signals from hand held mobile devices are received at the transmitter 401, processed into signals and transmitted to the core network.

In the case of a GSM or 2G network the signals are passed to a Mobile Switching Centre, MSC, 403, which routes calls. Upon first receiving signal from a mobile it will query the Home Location Register, HLR, 404, which holds data on mobile subscribers to verify if the signal received is from a mobile device which is subscribed to the network. In order to authenticate the mobile device it will use keys held in the Authentication Centre, AuC, 405.

In the case of a UTMS or 3G network the verified and authenticated signals may be routed through a Gateway Support Node 406.

In the case of an LTE or 4G network the signals are passed to a Mobility Management Entity, MME, 403 and the mobile is verified and authenticated at the Home Subscriber Server, HSS, 404/405. Calls are then further routed through a Serving Gateway 406 to a further network 407 which may be the internet.

FIG. 5 shows a flow diagram of an embodiment of detection of malicious behaviour suitable for detecting excessive attaches of a mobile device to a telecommunications network. In an advantageous embodiment a device attaches 501 to the network at time t₁ through a base station and the network registers the attach, identifies the mobile device and begins authentication procedures. In parallel with the normal processing of the attach request the network performs the following steps. A counter NA, a start time STA and a timer are initiated 502. Typically the counter will be set to zero and in an advantageous embodiment the timer set to time t₁ registered by the network. The counter value and start time are stored 503 for future reference. The next time an attach is registered for the same device, say at time t₂ the elapsed time T, equal to: t₂−STA

is compared with a predetermined time interval AA 504.

If: T=ΔA, or, T>ΔA,

the counter NA and the timer are cleared, 502.

If: T<ΔA,

the counter NA is increased by a value of 1 and the value of STA is replaced by the time t₂, 505. NA and STA are again stored 508. In this case the counter value is further compared with a predetermined threshold, LimitA, 506.

If: NA=LimitA,

an alert is set. If not, the method returns to step 504.

The skilled person will understand there are minor variations which can be made to the embodiment which will still work. For example, the counter could be increased if T is less than or equal to AA and only cleared if T is greater than AA. Also for example, LimitA could be a value which must be exceeded, in which case an alert flag would be set if NA>LimitA. In another advantageous embodiment a counter could be decremented instead of clearing the counter NA in step 502 if the value of the counter is larger than 0.

As the skilled person will understand, appropriate values for LimitA and the predetermined time interval ΔA will vary depending on the network and the customer base. However, suitable values are ΔA=500 ms and LimitA=10.

The method as described allows a network to detect malicious behaviour in the form of excessive attach requests from an infected mobile and in an advantageous embodiment would be performed in the MSC, Serving Gateway or MME of the network, as appropriate.

FIG. 6 shows a flow diagram of an embodiment of detection of malicious behaviour suitable for detecting excessive handovers of a mobile device in a telecommunications network and in a particularly advantageous embodiment would be performed in the MME of the network, which is informed of handovers before the handover takes place, referred to as an S1-handover, or after the handover has occurred, referred to as an X2-handover.

In order to carry out the method the MME performs the following steps for a group of mobile devices in its area. The group of devices monitored could be the group consisting of all mobile devices in its area, but could also be a sub-group of this group or some other further defined group. For example, the group of mobiles which are monitored could consist, say, of all new mobiles, or of mobiles whose previous activity suggests they might be at risk of infection, for example if they make frequent download requests, or of mobiles which are registered to particular users, says users who frequently change mobiles.

In this advantageous embodiment a device attaches 601 to the network at time t₁ through a base station and the network registers the attach, identifies the mobile device and begins authentication procedures. In parallel with the normal processing of the attach request the network performs the following steps. A counter NH, a start time STH and a timer are initiated 602. Typically the counter will be set to zero and in an advantageous embodiment the timer set to time t₁ registered by the network. The counter value and start time are stored 603 for future reference. The next time an attach is registered by the same device, say at time t₂ the elapsed time T, equal to:

t₂−STH

is compared to a predetermined time interval ΔH 604.

If: T=ΔH, or, T>ΔH,

the counter NH and the timer are cleared, 605.

If: T<ΔH,

the counter NH is increased by a value of 1 and the value of STH is replaced by the time t₂, 605. NH and STH are again stored 608. In this case the counter value is further compared with a predetermined threshold, LimitH, 606.

If: NH=LimitH,

an alert is set. If not, the method returns to step 604.

Again, the skilled person will understand there are minor variations which can be made to the embodiment which will still work. For example, the counter could be increased if T is less than or equal to AA and only cleared if T is greater than AA. Also for example, LimitH could be a value which must be exceeded, in which case an alert flag would be set if NH>LimitH.

The particular advantages of the invention are that a telecommunications network can monitor for malicious activity in mobile devices and identify when a particular device is potentially infected by malware. Although use of the invention requires network resources that would otherwise not be expended, it allows the easy identification of devices which may use up far greater network resources if left unidentified.

As the skilled person will understand, appropriate values for LimitH and the predetermined time interval ΔH will vary depending on the network and the customer base. However, suitable values are ΔH=2s and LimitH=20.

1. System to communicate with a mobile telecommunications device, the system comprising a telecommunications network and a mobile telecommunications device, arranged to communicate with each other,
wherein the mobile telecommunications device comprises:
a smart card,
a first security application,
and further wherein the smart card comprises a second security application,
wherein the mobile telecommunications device further comprises a secure logical channel between the first security application and the second security application,
and wherein the telecommunications network is arranged to produce data and signal the data to the mobile telecommunications device,
and further wherein the mobile telecommunications device is arranged to store the data in the second security application for access by the first security application.

2. A system according to claim 1, wherein the second security application is arranged to notify the first security application when the data is stored.

3. A system according to claim 1, wherein the second security application is arranged to set a flag when the data is stored and wherein the first security application is arranged to periodically check for the presence of the flag.

4. A system according to claim 1, wherein the smart card is a UICC.

5. A system according to claim 1 wherein the first security application is prompted to display a message to the user wherein the message is based upon the contents of the data.

6. A system according to claim 5, wherein the message includes instructions to guide the user to a helpdesk facility.

7. A system according to claim 1 wherein the security application is prompted to select and run a program within the mobile telecommunications device, wherein selection of the program is based upon the contents of the data.

8. A mobile telecommunications device, arranged to communicate with a telecommunications network, the mobile telecommunications device comprising:
a smart card,
a first security application,
and further wherein the smart card comprises a second security application,
a secure logical channel between the first security application and the second security application,
and further wherein the mobile telecommunications device is arranged to receive data from the telecommunications network,
and further wherein the mobile telecommunications device is arranged to store the data in the second security application for access by the first security application.
